(19) United States
(12) Patent Application Publication
(10) Pub. No.: US 2013/0249413 A1
(43) Pub. Date: Sep. 26, 2013

(54) LIGHT EMITTING ELEMENT PIXEL DRIVING CIRCUIT

(71) Applicants: WINTEK (CHINA) TECHNOLOGY LTD., Dongguan City (CN); WINTEK CORPORATION, Taichung City (TW)

(72) Inventors: Chun-Ho Chen, Changhua County (TW); Ching-Fu Hsu, Taichung City (TW); Yu-Hung Chang, Miaoli County (TW); Kuang-Wei Li, Taichung City (TW); Wen-Tui Liao, Taichung City (TW)

(73) Assignees: WINTEK CORPORATION, Taichung City (TW); Wintek (China) Technology Ltd., Dongguan City (CN)

(21) Appl. No.: 13/802,823

(22) Filed: Mar. 14, 2013

(30) Foreign Application Priority Data
Mar. 21, 2012 (TW) 101109629

(51) Int. Cl. H05B 37/02

(52) U.S. Cl. CPC H05B 37/0281
USPC 315/172

(57) ABSTRACT

A pixel circuit includes a control switch module, a capacitor, a driving switch, and a light emitting element. The control switch module is enabled and disabled according to a scan signal. A first end of the capacitor can be electrically connected to the control switch module, and a second end of the capacitor can be electrically connected to a voltage level. The capacitor receives and stores a predetermined driving voltage when the control switch module is enabled. Area of the capacitor occupies more than 20% area of the pixel circuit. The driving switch can be electrically connected to the capacitor and a voltage source for controlling a driving current flowing through the driving switch according to the predetermined driving voltage stored in the capacitor. The light emitting element emits light according to the driving current flowing through the driving switch.

### BACKGROUND OF THE INVENTION

1. Field of the Invention

The present invention relates to a light emitting element pixel driving circuit, and more particularly, to a light emitting element pixel driving circuit with large capacitance for reducing update frequency of driving voltage.

2. Description of the Prior Art

Please refer to FIG. 1. FIG. 1 is a diagram showing a light emitting element pixel driving circuit of the prior art. As shown in FIG. 1, the light emitting element pixel driving circuit of the prior art comprises a control switch 110, a capacitor 120, a driving switch 130, and a light emitting element 140. The control switch 110 is enabled or disabled according to a scan signal Vs. A first end of the capacitor 120 is electrically connected to the control switch 110. A second end of the capacitor 120 is electrically connected to a voltage level VSS. The capacitor 120 can receive and store a predetermined driving voltage Vd when the control switch is enabled. After the capacitor 120 stores the predetermined driving voltage Vd, the control switch 110 then will be disabled immediately. A first end t1 of the driving switch 130 can be electrically connected to a voltage source VDD, a second end t2 of the driving switch 130 can be electrically connected to the first end of the capacitor 120, and a third end t3 of the driving switch 130 can be electrically connected to the light emitting element 140 for instance. The driving switch 130 is for controlling a driving current Id flowing through the driving switch 130 according to the predetermined driving voltage Vd stored in the capacitor 120. For example, when the predetermined driving voltage Vd stored in the capacitor 120 is larger, a voltage difference between the second end t2 and the third end t3 of the driving switch 130 is larger as well, so as to increase the driving current Id flowing through the driving switch 130. When the driving voltage Vd stored in the capacitor 120 is smaller, the voltage difference between the second end t2 and the third end t3 of the driving switch 130 is smaller as well, so as to decrease the driving current Id flowing through the driving switch 130. The light emitting element 140 is for emitting light according to the driving current Id flowing through the driving switch 130. When the driving current Id becomes larger, brightness of the light emitting element 140 is higher; and when the driving current Id becomes smaller, the brightness of the light emitting element 140 is lower.

Please refer to FIG. 2, and refer to FIG. 1 as well. FIG. 2 is a diagram showing a layout of the light emitting element pixel driving circuit 100 in FIG. 1, wherein the layout of the light emitting element pixel driving circuit 100 represents a layout of a single pixel circuit. As shown in FIG. 2, the layout of the light emitting element pixel driving circuit 100 comprises a capacitor area A1 and a circuit area A2. The capacitor area A1 is a layout area of the capacitor 120. The circuit area A2 is a layout area of other circuit elements (such as the control switch 110 and the driving switch 130). In the light emitting element pixel driving circuit 100 of the prior art, the layout area of the capacitor area A1 is less than 10% of total area of the light emitting element pixel driving circuit 100. The layout area of the capacitor area A1 relates to capacitance of the capacitor 120. When the layout area of the capacitor area A1 is larger, the capacitance of the capacitor 120 is larger; and when the layout area of the capacitor area A1 is smaller, the capacitance of the capacitor 120 is smaller.

According to the above arrangement, when the light emitting element pixel driving circuit 100 of the prior art displays images, the predetermined driving voltage Vd stored in the capacitor 120 is getting lower due to leakage current when the control switch 110 is disabled. In order to prevent the leakage current affecting quality of displaying images, a display period of a frame of the light emitting element pixel driving circuit 100 of the prior art is shorter, so as to turn on the control switch 110 more frequently per unit time for updating the driving voltage Vd stored in the capacitor 120. However, when enabling the control switch 110 more frequently not only the service life of the control switch 110 is shortened, but also the power consumption of the light emitting element pixel driving circuit 100 is increased.

### SUMMARY OF THE INVENTION

The present invention provides a light emitting element pixel driving circuit. The light emitting element pixel driving circuit comprises a control switch module, a capacitor, a driving switch, and a light emitting element. The control switch module comprises a plurality of series control switches for being simultaneously enabled or disabled according to a scan signal. The capacitor is electrically connected to the control switch module for receiving and storing a predetermined driving voltage when the control switch module is enabled. The driving switch is for controlling a driving current flowing through the driving switch according to the predetermined driving voltage. The light emitting element is electrically connected to the driving switch for emitting light according to the driving current.

The present invention further provides a light emitting element pixel driving circuit. The light emitting element pixel driving circuit comprises a control switch module, a variable capacitor module, a driving switch, and a light emitting element. The control switch module is enabled or disabled according to a scan signal. A first end of the variable capacitor module is electrically connected to the control switch module, and a second end of the variable capacitor module is electrically connected to a voltage level. The variable capacitor module is for receiving and storing a predetermined driving voltage when the control switch module is enabled. The variable capacitor module changes its capacitance according to a capacitor control signal. The driving switch is electrically connected to the variable capacitor module and a voltage source for controlling a driving current flowing through the driving switch according to the predetermined driving voltage stored in the variable capacitor module. The light emitting element is for emitting light according to the driving current flowing through the control switch.

In contrast to the prior art, the light emitting element pixel driving circuit of the present invention is capable of reducing switching times of the driving switches, and further extending the service life of the driving switch as well as reducing the power consumption of the light emitting element pixel driving circuit. Moreover, the light emitting element pixel driving circuit of the present invention can flexibly adjust the capacitance for adaptively displaying the dynamic images or static images.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a light emitting element pixel driving circuit of the prior art.

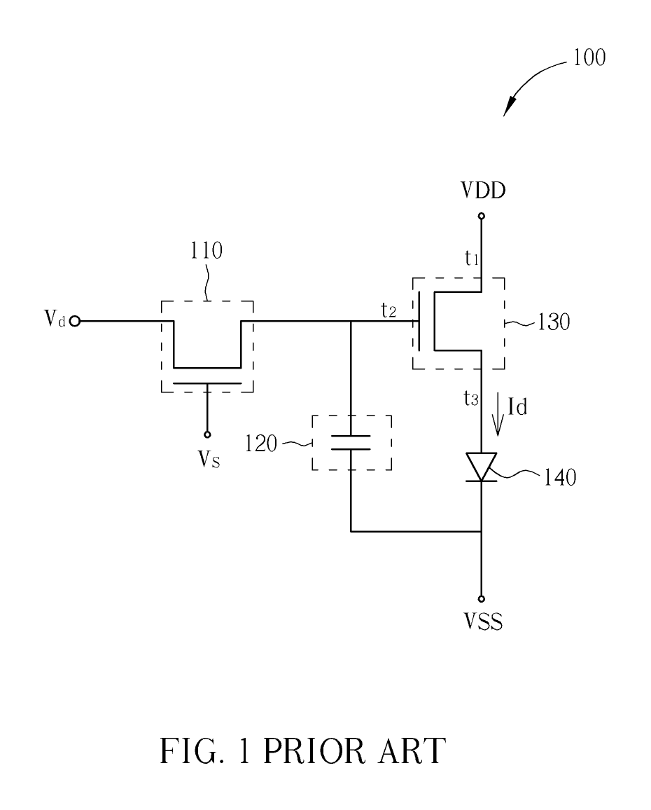

FIG. 2 is a diagram showing a layout of the light emitting element pixel driving circuit in FIG. 1.

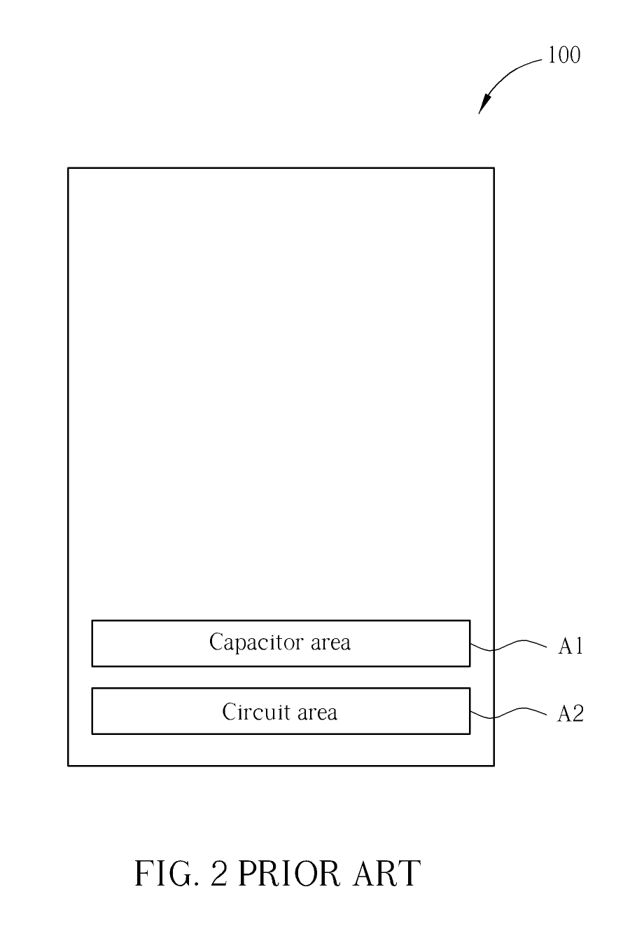

FIG. 3 is a diagram showing a light emitting element pixel driving circuit of the present invention.

FIG. 4 is a diagram showing a layout of the light emitting element pixel driving circuit in FIG. 3.

FIG. 5 is a diagram showing another embodiment of the light emitting element pixel driving circuit of the present invention.

### DETAILED DESCRIPTION

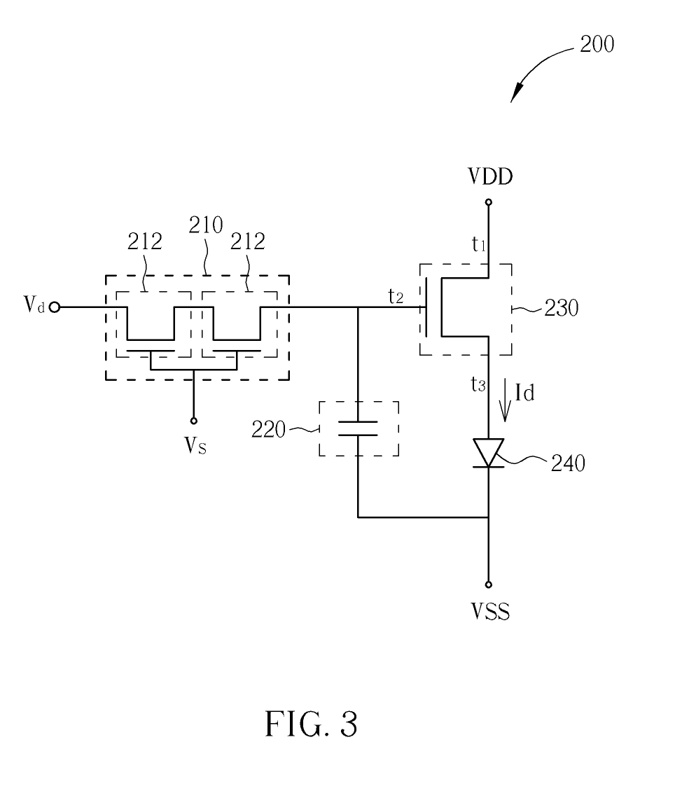

Please refer to FIG. 3. FIG. 3 is a diagram showing a light emitting element pixel driving circuit 200 of the present invention. As shown in FIG. 3, the light emitting element pixel driving circuit 200 of the present invention comprises a control switch module 210, a capacitor 220, a driving switch 230, and a light emitting element 240, wherein the light emitting element 240 can be an electroluminescent element, such as an organic light emitting diode (OLED), an inorganic light emitting diode, etc. The control switch module 210 comprises a plurality of series control switches 212. The control switches 212 of the control switch module 210 are simultaneously enabled or disabled according to a scan signal Vs. A first end of the capacitor 220 is electrically connected to the control switch module 210, and a second end of the capacitor 220 is electrically connected to a voltage level VSS. The capacitor 220 is for receiving and storing a predetermined driving voltage Vd when the control switches 212 of the control switch module 210 are enabled. After the capacitor 220 stores the predetermined driving voltage Vd, the control switches 212 of the control switch module 210 then will be disabled immediately. A first end t1 of the driving switch 230 can be electrically connected to a voltage source VDD, a second end t2 of the driving switch 230 can be electrically connected to the capacitor 220, and a third end t3 of the driving switch 230 can be electrically connected to the light emitting element 240 for instance. The driving switch 230 is for controlling a driving current Id flowing through the driving switch 230 according to the predetermined driving voltage Vd stored in the capacitor 220. For example, when the predetermined driving voltage Vd stored in the capacitor 220 is larger, a voltage difference between the second end t2 and the third end t3 of the driving switch 230 is larger as well, so as to increase the driving current Id flowing through the driving switch 230. When the driving voltage Vd stored in the capacitor 220 is smaller, the voltage difference between the second end t2 and the third end t3 of the driving switch 330 is smaller as well, so as to decrease the driving current Id flowing through the driving switch 230. The light emitting element 240 is for emitting light according to the driving current Id flowing through the driving switch 230. When the driving current Id becomes larger, brightness of the light emitting element 240 is higher; and when the driving current Id becomes smaller, the brightness of the light emitting element 240 is lower.

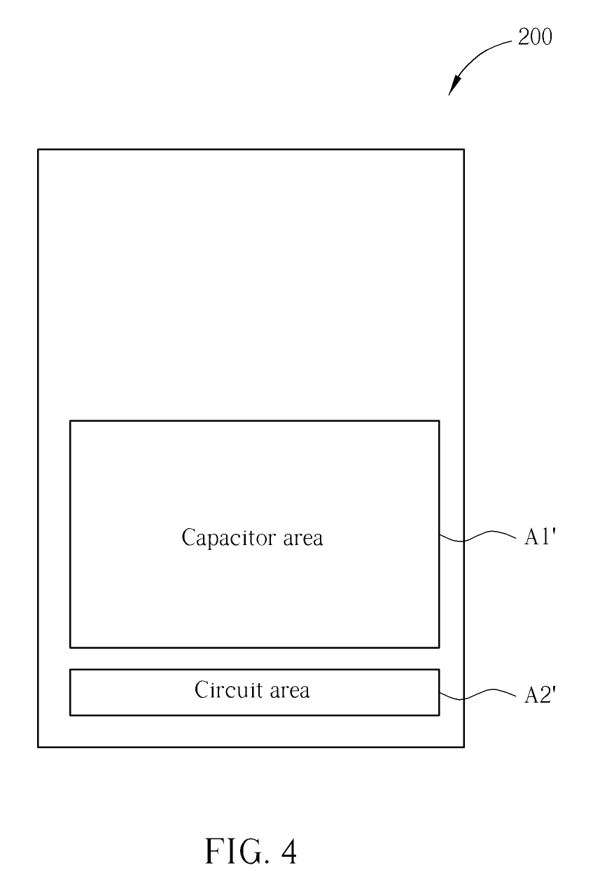

Please refer to FIG. 4, and FIG. 3 as well. FIG. 4 is a diagram showing a layout of the light emitting element pixel driving circuit 200 in FIG. 3, wherein the layout of the light emitting element pixel driving circuit 200 represents a layout of a single pixel circuit. As shown in FIG. 4, the layout of the light emitting element pixel driving circuit 200 comprises a capacitor area A1′ and a circuit area A2′. The capacitor area A1′ is a layout area of the capacitor 220. The circuit area A2′ is a layout area of other circuit elements (such as the control switch module 210 and the driving switch 230). In the light emitting element pixel driving circuit 200 of the present invention, the layout area of the capacitor area A1′ is more than 20% area of the light emitting element pixel driving circuit 200. That is, capacitance of the capacitor 220 of the light emitting element pixel driving circuit 200 of the present invention is more than double of capacitance of the capacitor 120 of the light emitting element pixel driving circuit 100 of the prior art.

When the light emitting element pixel driving circuit 200 of the present invention displays images, leakage current is smaller while the control switch module 210 is disabled due to the control switch module 210 comprising the plurality of series control switches 212. In addition, since the capacitance of the capacitor 220 of the light emitting element pixel driving circuit 200 of the present invention is more than twice as large as the capacitance of the capacitor 120 of the light emitting element pixel driving circuit 100 of the prior art, influence of the current leakage on the driving voltage Vd stored in the capacitor 220 is further reduced. According to the above arrangement, a display period of a frame can be extended. For example, the display period of the frame can be extended from 16.67 milliseconds to 1 second, such that reset rate for a frame according to the predetermined driving voltage Vd stored in the capacitor 220 can be reduced. That is, switching times of the control switches 212 of the control switch module 210 per unit time can be reduced. Especially when displaying a static image, the control switches 212 of the control switch module 210 are only required to be enabled one time for allowing the light emitting element pixel driving circuit 200 displaying a same image for a longer period. Therefore, service life of the control switches 212 of the light emitting element pixel driving circuit 200 is increased, and power consumption of the light emitting element pixel driving circuit 200 is reduced.

In addition, in a display period of a frame, when the light emitting element 240 emits light, the voltage level VSS can be a ground level (such as 0 volt), and when the light emitting element 240 does not emit light, the voltage level VSS can be a negative level (such as −5 volt) for pulling down a voltage level of the first end of the capacitor 220 (that is, a voltage level of the second end t2 of the driving switch 230) to 0 volt, such that the driving switch 230 can be exactly disabled when the light emitting element 240 does not emit light.

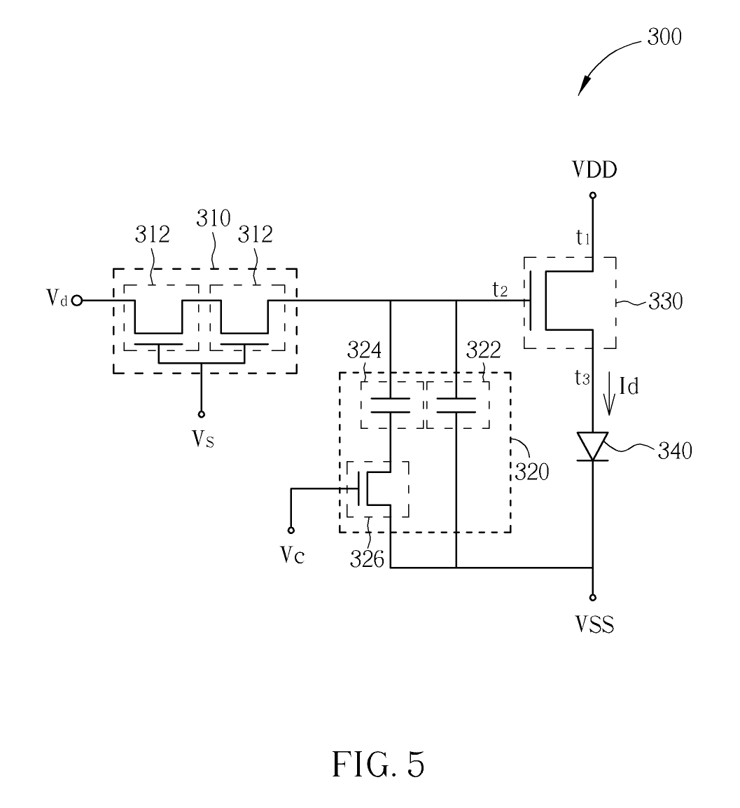

Please refer to FIG. 5. FIG. 5 is a diagram showing another embodiment of a light emitting element pixel driving circuit 300 of the present invention. As shown in FIG. 5, the light emitting element pixel driving circuit 300 of the present invention comprises a control switch module 310, a variable capacitor module 320, a driving switch 330, and alight emitting element 340. The control switch module 310, the driving switch 330, and the light emitting element 340 in FIG. 5 are respectively identical to the control switch module 210, the driving switch 230, and the light emitting element 240 in FIG. 3. Therefore, no further illustration is provided. The variable capacitor 320 comprises a first capacitor 322, a second capacitor 324, and a capacitor control switch 326. A first end of the first capacitor 322 can be electrically connected to the control switch module 310, and a second end of the first capacitor 322 can be electrically connected to a voltage level VSS. A first end of the second capacitor 324 can be electrically connected to the control switch module 310, and a second end of the second capacitor 324 can be electrically connected to the capacitor control switch 326. Capacitance of the second capacitor 324 is larger than capacitance of the first capacitor 322. The capacitor control switch 326 is electrically connected between the second end of the second capacitor 324 and the voltage level VSS for being enabled or disabled according to a capacitor control signal Vc. When the capacitor control switch 326 is disabled, capacitance of the variable capacitor module 320 is equal to the capacitance of the first capacitor 322. When the capacitor control switch 326 is enabled, the capacitance of the variable capacitor module 320 is equal to a sum of the capacitance of the first capacitor 322 and the capacitance of the second capacitor 324.

According to the above arrangement, when the light emitting element pixel driving circuit 300 is utilized for displaying dynamic images, the capacitor control switch 326 can be disabled in order to reduce the capacitance of the variable capacitor module 320, and further reduce charging time of the variable capacitor module 320; and when the light emitting element pixel driving circuit 300 is utilized for displaying static images, the capacitor control switch 326 can be enabled in order to increase the capacitance of the variable capacitor module 320, and further extend a display period of a same image displayed by the light emitting element pixel driving circuit 300.

In addition, the plurality of series control switches 212, 312 of the control switch modules 210, 310 can be indium gallium zinc oxide (IGZO) thin-film transistors. The IGZO thin-film transistors have better current conductivity for allowing larger current passing through when the control switch module is enabled, so as to rapidly charge the capacitors 220, 322, 324 to a predetermined level.

In contrast to the prior art, the light emitting element pixel driving circuit of the present invention is capable of reducing the switching times of the driving switches, and further extending the service life of the driving switch as well as reducing the power consumption of the light emitting element pixel driving circuit. Moreover, the light emitting element pixel driving circuit of the present invention can flexibly adjust the capacitance for adaptively displaying the dynamic images or static images.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light emitting element pixel driving circuit, comprising:
a control switch module comprising a plurality of series control switches for being simultaneously enabled and disabled according to a scan signal;
a first capacitor electrically connected to the control switch module for receiving and storing a predetermined driving voltage when the control switch module is enabled;
a driving switch for controlling a driving current flowing through the driving switch according to the predetermined driving voltage; and
a light emitting element electrically connected to the driving switch for emitting light according to the driving current.

2. The pixel driving circuit of claim 1, wherein a first end of the first capacitor is electrically connected to the control switch module, a second end of the first capacitor is electrically connected to a voltage level, the voltage level is a ground level when the light emitting element emits light, and the voltage level is a negative level when the light emitting element does not emit light.

3. The pixel driving circuit of claim 1, wherein area of the first capacitor occupies more than 20% area of the light emitting element pixel driving circuit.

4. The pixel driving circuit of claim 1, wherein the plurality of series control switches are indium gallium zinc oxide thin film transistors.

5. The pixel driving circuit of claim 1, wherein the driving switch is electrically connected to the first capacitor, the light emitting element, and a voltage source.

6. A light emitting element pixel driving circuit, comprising:
a control switch module comprising a plurality of series control switches for being enabled and disabled according to a scan signal;
a variable capacitor module with a first end electrically connected to the control switch module, a second end electrically connected to a voltage level, for receiving and storing a predetermined driving voltage when the control switch module is enabled, the variable capacitor module changing its capacitance according to a capacitor control signal;
a driving switch electrically connected to the variable capacitor module and a voltage source for controlling a driving current flowing through the driving switch according to the predetermined driving voltage stored in the variable capacitor module; and
a light emitting element for emitting light according to the driving current flowing through the control switch.

7. The pixel driving circuit of claim 6, wherein the voltage level is a ground level when the light emitting element emits light, and the voltage level is a negative level when the light emitting element does not emit light.

8. The pixel driving circuit of claim 6, wherein the driving switch is electrically connected to the variable capacitor module, the light emitting element, and a voltage source.

9. The pixel driving circuit of claim 6, wherein the plurality of series control switches are indium gallium zinc oxide thin-film transistors.

10. The pixel driving circuit of claim 6, wherein the variable capacitor module comprises:
a first capacitor with a first end electrically connected to the control switch module, and a second end electrically connected to the voltage level;
a second capacitor with a first end electrically connected to the control switch module; and
a capacitor control switch electrically connected between a second end of the second capacitor and the voltage level for being enabled or disabled according to the capacitor control signal.

11. The pixel driving circuit of claim 10, wherein capacitance of the second capacitor is greater than capacitance of the first capacitor.
